(19) United States
(12) Patent Application Publication
(10) Pub. No.: US 2014/0330837 A1
(43) Pub. Date: Nov. 6, 2014

(54) METHOD, APPARATUS AND SYSTEM FOR PUSHING MICRO-BLOGS

(71) Applicant: TENCENT TECHNOLOGY (SHENZHEN) COMPANY LIMITED, Shenzhen (CN)

(72) Inventors: Li LIU, Shenzhen (CN); Jun SHU, Shenzhen (CN); Ming TIAN, Shenzhen (CN)

(21) Appl. No.: 14/335,578

(22) Filed: Jul. 18, 2014

Related U.S. Application Data
(63) Continuation of application No. PCT/CN2013/089128, filed on Dec. 11, 2013.

(30) Foreign Application Priority Data
Apr. 17, 2013 (CN) 201310134534.9

(51) Int. Cl. G06F 17/30

(52) U.S. Cl. CPC G06F 17/30321
USPC 707/741

(57) ABSTRACT

A method for pushing micro-blogs is provided. The method is performed at micro-blog pushing server. In this method, a set of keywords is determined, each keyword is associated with at least one of micro-blogs received at a micro-blog receiving server, an index of the plurality of micro-blogs is created using the set of keywords, a subset of keywords, each having an interest value greater than a preset threshold, are obtained, micro-blogs associated with the obtained keywords are searched for, the searched out micro-blogs are sorted based on a timeline or based on relevancies of the micro-blogs to the keywords having interest values greater than a preset threshold, and then the sorted micro-blogs are pushed to the user. In addition, an apparatus, a system and a non-transitory computer-readable storage medium related to the method are also provided.

### CROSS REFERENCE TO RELATED APPLICATIONS

The present patent application is a U.S. continuation application under 35 U.S.C. §111(a) claiming priority under 35 U.S.C. §§120 and 365(c) to International Application No. PCT/CN2013/089128 filed on Dec. 11, 2013, which claims priority of Chinese patent application No. 201310134534.9, entitled “Method, System and Server for Pushing Micro-Blogs” and filed by applicant Tencent Technology (Shenzhen) Co., Ltd on Apr. 17, 2013. The applications are incorporated into the present application by reference in their entity.

### TECHNICAL FIELD

The disclosure generally relates to social media network techniques, and in particular to a method, apparatus and system for pushing micro-blogs.

### BACKGROUND

Micro-blogging enables micro-blogging users or members to broadcast their current status or share information of their interests, activities, opinions, etc. in relatively short posts.

A micro-blogging service offered to a micro-blogging user includes both a social attribute and a media attribute. The social attribute is associated with a listening relation-chain of the micro-blogging user, such as friends, colleagues, and famous persons, etc., micro-blogs posted and/or forwarded by whom are listened to by the micro-blogging user. The media attribute is associated with contents of micro-blogs posted, forwarded and/or listened to by the micro-blogging user. Apparently, the media attribute is based on the social attribute. Specifically, if the micro-blogging user wishes to improve the media attribute of the micro-blogging service offered to him/her, the micro-blogging user has to improve the social attribute. In other words, if micro-blogging user wishes to view specific contents of micro-blogs posted by many other micro-blogging users, he/she has to expand his/her listening relation-chain.

However, if the micro-blogging user improves the media attribute of the micro-blogging service offered to him/her through expanding his/her listening relation-chain, it would result in a large listening relation-chain. In this case, the micro-blogging user may receive a huge amount of micro-blogs, some of which, however, may be of no interest to the micro-blogging user. Such micro-blogs become noises annoying the micro-blogging user and thus affect user experiences.

### SUMMARY

According to various aspect of the disclosure, a method, an apparatus and a system for pushing micro-blogs are provided, which are capable of reducing a degree of coupling of the social attribute to the media attribute of the micro-blogging service, such that the media attribute of the micro-blogging service can be improved without expanding the listening relation-chain, so as to avoid noises and disturbances.

According to an aspect of the disclosure, a method for pushing micro-blogs is provided. The method is performed at a micro-blog pushing server. The method includes the following steps: determining a set of keywords, each keyword being associated with at least one of a plurality of micro-blogs received by a micro-blog receiving server; creating an index of the plurality of micro-blogs using the set of the keywords; obtaining a subset of the keywords, each having an interest value greater than a preset threshold; searching in the index for micro-blogs associated with the subset of the keywords; sorting the micro-blogs searched out based on a predefined rule; and transmitting the sorted micro-blogs for the user, wherein the set of the keywords contain content keywords, geographical location information keywords, or both.

According to another aspect of the disclosure, an apparatus for pushing micro-blogs is provided. The apparatus includes a determining module, configured to determine a set of keywords, each being associated with at least one of a plurality of micro-blogs; a creating module, configured to create an index of the plurality of micro-blogs using the set of the keywords; an obtaining module, configured to obtain a subset of the keywords, each having an interest value greater than a preset threshold; a searching module, configured to search in the index for micro-blogs associated with the subset of the keywords; a sorting module, configured to sort the micro-blogs searched out based on a predefined rule; and a transmitting module, configured to transmit the sorted micro-blogs for the user, wherein the set of the keywords contain content keywords, geographical location information keywords, or both.

According to yet another aspect of the disclosure, a micro-blog pushing server is provided. The micro-blog pushing server includes a processor and a memory. The memory is coupled to the processor and includes instructions that, when executed, cause the processor to perform the above method.

According to yet another aspect of the disclosure, a system is provided. The system includes a network-side device and a terminal-side device. The network-side device includes a micro-blog pushing server as described above. The terminal-side device is configured to receive the micro-blogs from the micro-blog pushing server and to present the micro-blogs.

According to yet another aspect of the disclosure, a non-transitory computer-readable storage medium is provided, which includes instructions that, when executed, cause one or more processors to perform the above method.

According to the various aspects of the disclosure, the apparatus for pushing micro-blogs can automatically acquire content keywords and/or geographical location information keywords that a user is interested in from micro-blogs associated with the user, take the content keywords and/or geographical location information keywords as a search entry to search for micro-blogs associated with the content keywords and/or geographical location information keywords, sort the searched out micro-blogs based on a timeline and/or relevancies of the micro-blogs to the content keywords and/or geographical location information keywords that the user is interested in, and transmit the sorted micro-blogs for the user. In this way, the user can acquire micro-blogs relevant to a historical micro-blog posted by himself/herself without expanding the listening relation-chain. Additionally, the media attribute of the micro-blogging service offered to the user can be improved by reducing the coupling of the social attribute to the media attribute. Further, according to the various aspects of the disclosure, expansion of the listening relation-chain of the user, which may cause noises and disturbances, is suppressed, and thus user experiences on the micro-blogging service are improved.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

These and other sample aspects of the disclosure will be described in the detailed description and the claims that follow, and in the accompanying drawings, wherein:

FIG. 1 is a flow chart illustrating a method for pushing micro-blogs according to some embodiments of the disclosure;

FIG. 2 is a flow chart illustrating operations performed at a server and a mobile terminal for pushing and presenting micro-blogs according to some embodiments of the disclosure;

FIG. 3 illustrates a schematic view for an example of gathering, sorting and presenting relevant micro-blogs according to some embodiments of the disclosure;

FIG. 4 illustrates a schematic view for an example of gathering, sorting and presenting relevant micro-blogs according to some embodiments of the disclosure;

FIG. 5 is a simplified block diagram illustrating an apparatus for pushing micro-blogs according to some embodiments of the disclosure;

FIG. 6 is a structure schematic view illustrating an electronic device for pushing micro-blogs according to some embodiments of the disclosure; and

FIG. 7 is a structure schematic view illustrating a system for pushing micro-blogs according to some embodiments of the disclosure.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

Reference throughout this specification to “an example,” “an embodiment,” or the like in the singular or plural means that one or more particular features, structures, or characteristics described in connection with an embodiment is included in at least one embodiment of the present disclosure. Thus, the appearances of the phrases “an example,” “an embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

According to various embodiments of the disclosure, operations of pushing micro-blogs are performed by a micro-blog pushing server. The micro-blog pushing server determines a set of content keywords and/or geographical location information keywords, each of which is associated with at least one of micro-blogs received at a micro-blog receiving server, and creates an index of the plurality of micro-blogs using the set of content keywords and/or geographical location information keywords; before pushing micro-blogs to a user, the micro-blog pushing server obtains one or more content keywords and/or geographical location information keywords that the user is interested in, searches for micro-blogs associated with the obtained content keywords and/or geographical location information keywords, sorts the searched out micro-blogs based on a timeline or based on relevancies of the micro-blogs to the content keywords and/or geographical location information keywords that the user is interested in; and then the micro-blog pushing server transmits the sorted micro-blogs for the user.

Here, the micro-blog pushing server and the micro-blog receiving server may be a same physical device or may be different physical devices.

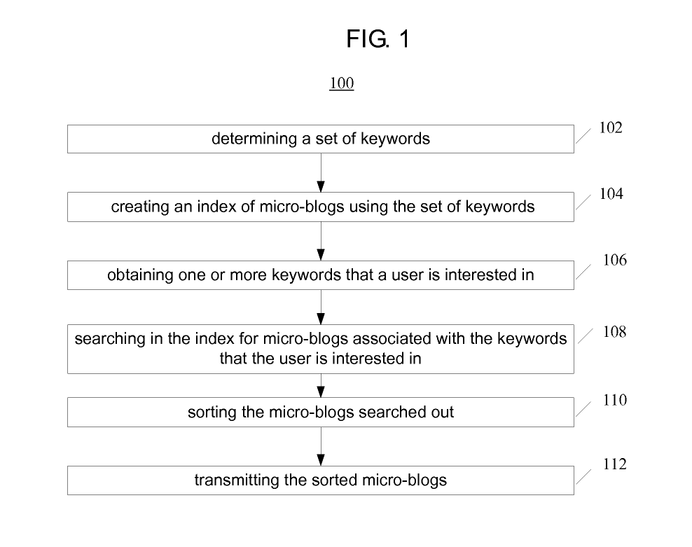

FIG. 1 is a flow chart illustrating a method 100 for pushing micro-blogs according to some embodiments of the disclosure. As shown in FIG. 1, the method 100 includes steps as follows.

Step 102: a micro-blog pushing server determines a set of content keywords and/or geographical location information keywords.

Each of the content keywords and/or geographical location information keywords is associated with at least one of a plurality of micro-blogs received at a micro-blog receiving server. For example, a content keyword may consist of one or more words extracted from a content of a micro-blog, and a geographical location information keyword may indicate a geographical location at which a micro-blog is transmitted, or may be a keyword that is mentioned in the content of the micro-blog.

Step 104: the micro-blog pushing server creates an index of the plurality of micro-blogs, using the determined set of content keywords and/or geographical location information keywords.

In an embodiment, the micro-blog pushing server fetches a micro-blog from all of the received micro-blogs each time, detects whether the fetched micro-blog has a content that matches at least one of the set of content keywords and/or geographical location information keywords or whether the fetched micro-blog was transmitted at a geographical location that falls within the set of geographical location information keywords. If yes, the corresponding content keyword and/or geographical location information keyword is indexed to the fetched micro-blog.

Step 106: the micro-blog pushing server obtains one or more content keywords and/or geographical location information keywords, each having an interest value greater than a preset threshold.

In an embodiment, each content keyword and/or geographical location information keyword is assigned with an interest value. If a content keyword and/or geographical location information keyword has an interest value greater than a preset threshold, it is taken as a content keyword and/or geographical location information keyword that a user is interested in. For example, the threshold may be preset as zero, and the interest value of a certain content keyword and/or geographical location information keyword may be increased by 1 in at least one of the following cases: a user inputs the content keyword and/or geographical location information keyword, the user selects the content keyword and/or geographical location information keyword from what are provided from the micro-blog pushing server, or the micro-blog pushing server obtains the content keyword and/or geographical location information keyword from a historical micro-blog that the user has posted or listened to.

In an embodiment, the historical micro-blog may include one of the following: a last micro-blog that the user has posted, micro-blogs that the user posted during a specified period, or all micro-blogs that the user has posted.

In an embodiment, the micro-blog pushing server matches the historical micro-blog with the set of content keywords and/or geographical location information keywords; if the historical micro-blog has a content that matches at least one of the set of content keywords and/or geographical location information keywords or the historical micro-blog was transmitted at a geographical location that falls within the set of geographical location information keywords, the micro-blog pushing server takes the corresponding content keyword and/or geographical location information keyword as the content keyword and/or geographical location information keyword that the user is interested in.

In an embodiment, after the user writes a micro-blog, the user sets one or more content keywords for the micro-blog, and then transmits the micro-blog along with the content keywords to the micro-blog pushing server. Accordingly, the micro-blog pushing server takes the one or more content keywords set by the user as the content keywords that the user is interested in.

In an embodiment, the micro-blog pushing server records the geographical location of a mobile terminal from which the historical micro-blog is transmitted, and takes the geographical location as the geographical location information keyword that the user is interested in. In this embodiment, the geographical location of the mobile terminal from which the historical micro-blog is transmitted may be recorded by employing existing technical means. For example, the geographical location information may be acquired by applying a mobile communication network location mechanism, the detailed description of which is omitted here. In this embodiment, the micro-blog pushing server may record a type of the mobile terminal from which the historical micro-blog is transmitted. This can also be implemented by employing existing technical means, the detailed description of which is omitted here.

In an embodiment, when the micro-blog pushing server receives a new micro-blog from the user, or when the micro-blog pushing server receives a request for relevant micro-blogs from the user, the micro-blog pushing server turns to perform step 106. In another embodiment, the micro-blog pushing server pushes micro-blogs to the user periodically.

Step 108: the micro-blog pushing server searches in the index for micro-blogs associated with the content keywords and/or geographical location information keywords that the user is interested in.

In an embodiment, the micro-blog pushing server traverses the index to extract one or more index entries corresponding to the content keywords and/or geographical location information keywords that the user is interested in, and obtains micro-blogs corresponding to the index entries as the micro-blogs associated with the content keywords and/or geographical location information keywords that the user is interested in.

Step 110: the micro-blog pushing server sorts the micro-blogs searched out based on a predefined rule.

In an embodiment, the micro-blogs are sorted based on a timeline. For example, a recently posted micro-blog may be sorted close to the top.

In another embodiment, the micro-blogs are sorted based on relevancies of the micro-blogs to the content keyword and/or geographical location information keyword that the user is interested in. For example, the micro-blog which has a high relevance to the content keyword and/or geographical location information keyword that the user is interested in may be sorted close to the top.

As appreciated by one of ordinary skill in the art, the user may be interested in more than one content keywords and/or more than one geographical location information keywords. The number of content keywords and/or geographical location information keywords contained in a micro-blog, which fall within the content keywords and/or geographical location information keywords that the user is interested in, represents the relevancy. The higher the relevancy is, the closer to the top the micro-blog is sorted. In an embodiment, the micro-blogs are sorted in a descending order of their respective relevancies, and then the micro-blogs that have a same relevancy are sorted based on the timeline.

In an embodiment, after sorting the searched out micro-blogs, the micro-blog pushing server may obtain a listening list of the user, and cancel one or more micro-blogs which occur in the listening list of the user from the sorted micro-blogs, so as to prevent a repetition of pushing.

Step 112: the micro-blog pushing server transmits the sorted micro-blogs for the user.

In an embodiment, when the micro-blogs are received at a mobile terminal from the micro-blog pushing server, and the user views the micro-blogs through the mobile terminal, two tab pages may be presented, in a first tab page, micro-blogs in the user's listening chain are sorted based on a timeline and presented, and in a second tab page, relevant micro-blogs associated with content keyword and/or geographical location information keyword that the user is interested in are presented.

Although FIG. 1 illustrates a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives.

Moreover, the ordinary skilled in the art may understand that all or part of the flow in the method of the embodiments may be implemented through associated hardware controlled by computer programs, which may be stored in a non-transitory computer readable storage medium and may when executed include the flow mentioned in the embodiments of the above methods. In an embodiment, the computer readable storage medium may implement at least some portions of the memory. The computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or any other suitable computer-readable storage medium.

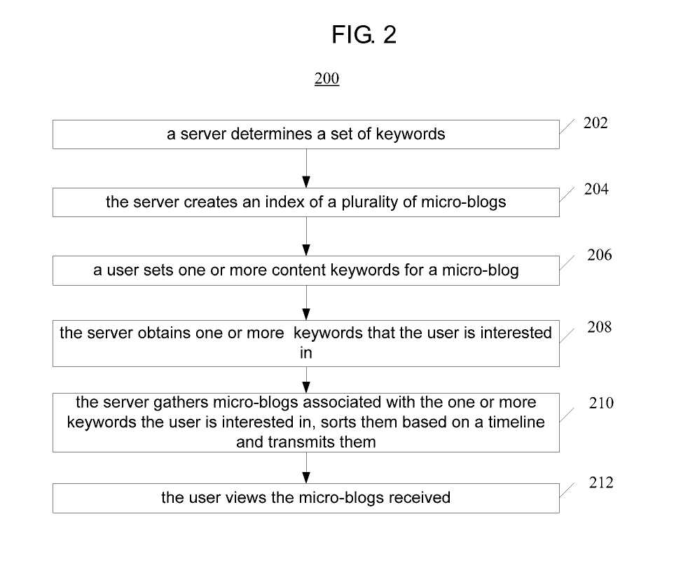

FIG. 2 is a flow chart illustrating operations 200 performed at a server and a mobile terminal for pushing and presenting micro-blogs according to some embodiments of the disclosure. In the embodiments, the server implements the functions of both the micro-blog pushing server and the micro-blog receiving server as described above. As shown in FIG. 2, micro-blogs associated with one or more content keywords and/or geographical location information keywords that the user is interested in are searched out, sorted based on a timeline and pushed to the user. Specifically, the following steps are performed.

Here, the micro-blogs associated with one or more content keywords and/or geographical location information keywords that the user is interested in are referred to as relevant micro-blogs.

Step 202: a server determines a set of content keywords and/or geographical location information keywords.

Here, each of the content keywords and/or geographical location information keywords is associated with at least one of a plurality of micro-blogs received at the server.

Step 204: the server creates an index of the plurality of the micro-blogs, using the determined set of content keywords and/or geographical location information keywords.

Step 206: when a user posts a micro-blog, the user sets one or more content keywords for the micro-blog, and then transmits the micro-blog along with the content keywords to the server.

Here, the content keywords may be set by the user according to the practical situation. For example, the content keywords are extracted from the micro-blog.

Step 208: the server, after receiving the micro-blog from the user, obtains one or more content keywords and/or geographical location information keywords, each having an interest value greater than a preset threshold.

When a content keyword and/or geographical location information keyword has an interest value greater than the preset threshold, the server takes it as a content keyword and/or geographical location information keyword that the user is interested in.

In an embodiment, the server may create one or more index entries for this micro-blog, based on the determined set of content keywords and/or geographical location information keywords.

In an embodiment, the server may record the geographical location information of the micro-blog backstage when posting the micro-blog for the user.

Step 210: when it is desired to push micro-blogs to the user, the server gathers micro-blogs associated with the one or more content keywords and/or geographical location information keywords that the user is interested in, sorts them based on a timeline, and transmits them for the user.

Here, the micro-blogs associated with content keywords and/or geographical location information keywords that the user is interested in are referred to as relevant micro-blogs.

Step 212: when the user views a micro-blogging home page through the mobile terminal, two tab pages are presented for the user's choice. In a first tab page, micro-blogs in the user's listening relation-chain are sorted based on a timeline and presented, and in a second tab page, relevant micro-blogs are sorted based on a timeline and presented.

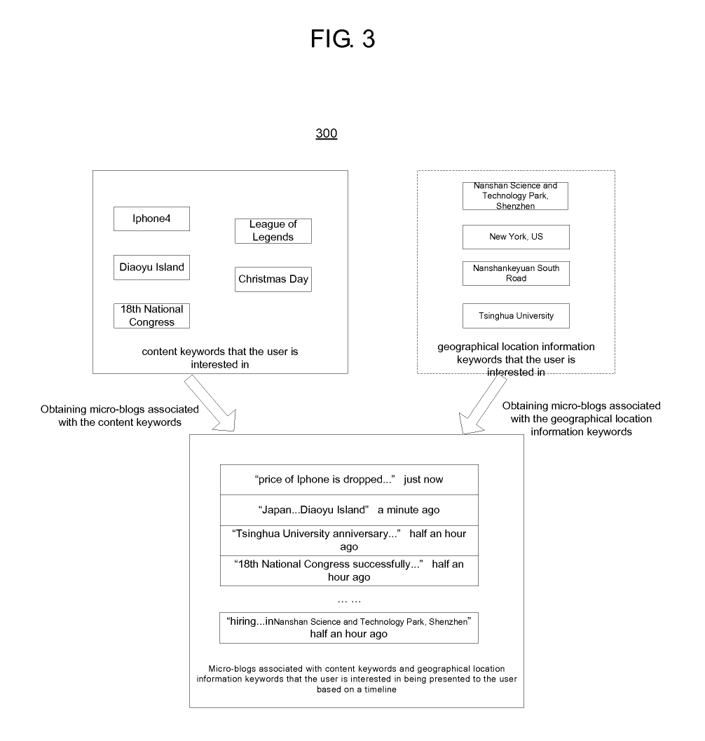

FIG. 3 illustrates a schematic view for an example 300 of gathering, sorting and presenting relevant micro-blogs according to some embodiments of the disclosure.

As shown in FIG. 3, a user is interested in following content keywords: “Iphone 4”, “Diaoyu Island”, “18th National Congress”, etc., and the user is interested in following geographical location information keywords: “Nanshan Science and Technology Park, Shenzhen”, “New York, US”, “Nanshankeyuan South Road”, “Tsinghua University”. For micro-blogs which have no relevancy or have a same relevancy to the content keywords or the geographical location information keywords, they are sorted based on a timeline and presented to the user.

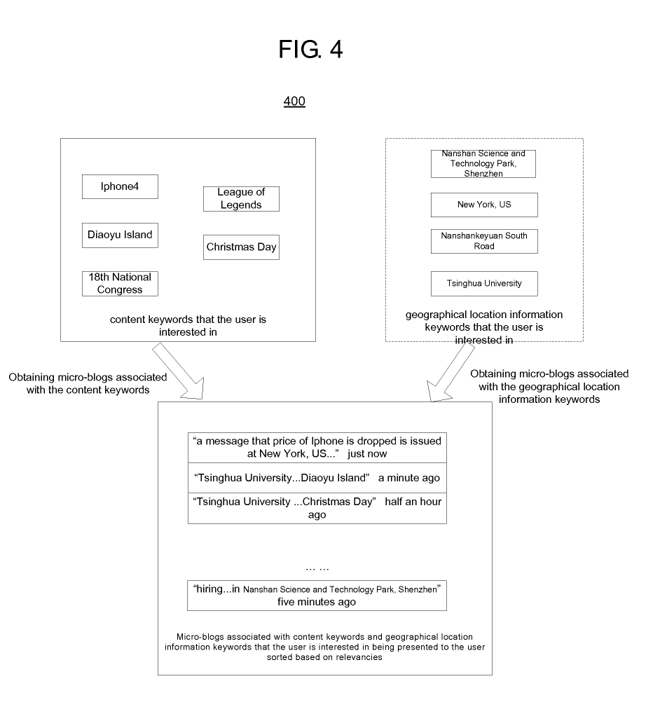

FIG. 4 illustrates a schematic view for an example 400 of gathering, sorting and presenting relevant micro-blogs according to some embodiments of the disclosure.

As shown in FIG. 4, a user is interested in following content keywords: “Iphone 4”, “Diaoyu Island”, “18th National Congress”, etc., and the user is interested in following geographical location information keywords: “Nanshan Science and Technology Park, Shenzhen”, “New York, US”, “Nanshankeyuan South Road”, “Tsinghua University”. For micro-blogs which have their respective relevancies (being different from each other) to the content keywords or the geographical location information keywords, they are sorted based on their respective relevancies and presented to the user.

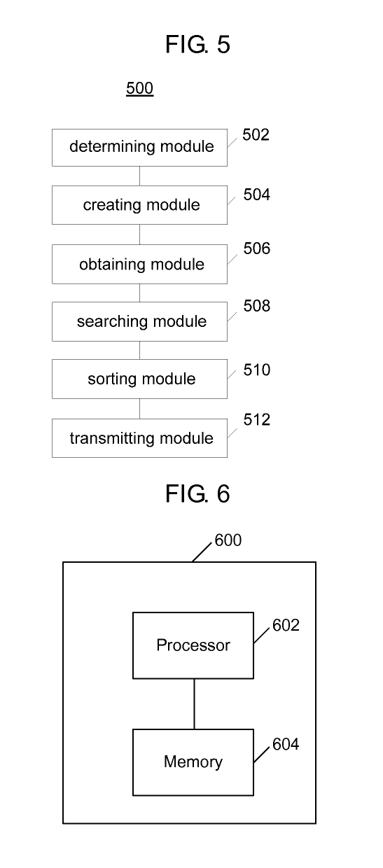

FIG. 5 is a simplified block diagram illustrating an apparatus 500 for pushing micro-blogs according to some embodiments of the disclosure.

As shown in FIG. 5, the apparatus 500 includes a determining module 502, a creating module 504, an obtaining module 506, a searching module 508, a sorting module 510 and a transmitting module 512.

The determining module 502 is configured to determine a set of content keywords and/or geographical location information keywords. Here, each of the content keywords and/or geographical location information keywords is associated with at least one of a plurality of micro-blogs received at a micro-blog receiving server as described above. For example, a content keyword may consist of one or more words extracted from a content of a micro-blog, and a geographical location information keyword may indicate a geographical location at which a micro-blog is transmitted, or may be extracted from the content of the micro-blog.

The creating module 504 is configured to create an index of the plurality of micro-blogs, using the determined set of content keywords and/or geographical location information keywords.

In an embodiment, the creating module 504 fetches a micro-blog from all of the received micro-blogs each time, detects whether the fetched micro-blog has a content that matches at least one of the set of content keywords and/or geographical location information keywords or whether the fetched micro-blog was transmitted at a geographical location that falls within the set of geographical location information keywords. If yes, the creating module 504 indexes the fetched micro-blog to the corresponding content keyword and/or geographical location information keyword.

The obtaining module 506 is configured to obtain one or more content keywords and/or geographical location information keywords, each having an interest value greater than a preset threshold.

In an embodiment, each content keyword and/or geographical location information keyword is assigned with an interest value. If a content keyword and/or geographical location information keyword has an interest value greater than a preset threshold, it is taken as a content keyword and/or geographical location information keyword that a user is interested. For example, the threshold may be preset as zero, and the interest value of a certain content keyword and/or geographical location information keyword may be increased by 1 in at least one of the following cases: a user inputs the content keyword and/or geographical location information keyword input by the user, the user selects the content keyword and/or geographical location information keyword from what are provided from the micro-blog pushing server, or the micro-blog pushing server obtains the content keyword and/or geographical location information keyword from a historical micro-blog that the user has posted or listened to.

In an embodiment, the historical micro-blog may include one of the following: a last micro-blog that the user has posted, micro-blogs that the user posted during a specified period, or all micro-blogs that the user has posted.

In an embodiment, the obtaining module 506 matches the historical micro-blog with the set of content keywords and/or geographical location information keywords; if the historical micro-blog has a content that matches at least one of the set of content keywords and/or geographical location information keywords or the historical micro-blog was transmitted at a geographical location that falls within the set of geographical location information keywords, the obtaining module 506 takes the corresponding content keyword and/or geographical location information keyword as the content keyword and/or geographical location information keyword that the user is interested in.

In an embodiment, after the user writes a micro-blog, the user sets one or more content keywords for the micro-blog, and then transmits the micro-blog along with the content keywords to the micro-blog pushing server. Accordingly, the obtaining module 506 takes the one or more content keywords set by the user as the content keywords that the user is interested in.

The searching module 508 is configured to search in the index for micro-blogs associated with the content keywords and/or geographical location information keywords that the user is interested in.

In an embodiment, the searching module 508 traverses the index to extract one or more index entries corresponding to the content keyword and/or geographical location information keyword that the user is interested in, and obtains micro-blogs corresponding to the index entries as the micro-blogs associated with the content keywords and/or geographical location information keywords that the user is interested in.

The sorting module 510 is configured to sort the micro-blogs searched out based on a predefined rule. In an embodiment, the micro-blogs are sorted based on a timeline. For example, a recently posted micro-blog may be sorted close to the top. In another embodiment, the micro-blogs are sorted based on relevancies of the micro-blogs to the content keyword and/or geographical location information keyword that the user is interested in. For example, the micro-blog which has a high relevance to the content keyword and/or geographical location information keyword that the user is interested in may be sorted close to the top.

As appreciated by one of ordinary skill in the art, the user may be interested in more than one content keywords and/or more than one geographical location information keywords. The number of content keywords and/or geographical location information keywords contained in a micro-blog, which fall within the content keywords and/or geographical location information keywords that the user is interested in, represents the relevancy. The higher the relevancy is, the closer to the top the micro-blog is sorted. In an embodiment, the micro-blogs are sorted in a descending order of their respective relevancies, and then the micro-blogs that have a same relevancy are sorted based on the timeline.

The transmitting module 512 is configured to transmit the sorted micro-blogs for the user.

In an embodiment, the various modules in the apparatus 500 may be implemented as a software component within a memory of an electronic device. However, it should be noted that this is just an illustrative embodiment, and the disclosure is not limited to this embodiment. For example, the terms “apparatus”, and “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term “module” may include memory (shared, dedicated, or group) that stores code executed by the processor.

FIG. 6 is a structure schematic view illustrating a micro-blog pushing server 600 for pushing micro-blogs according to an embodiment of the disclosure.

This disclosure contemplates any suitable types of micro-blog pushing servers 600. In an embodiment, software running on the one or more micro-blog pushing servers performs one or more steps of at least one of the methods as described referring to FIG. 1 or implements functions of some or all of the various modules as described referring to FIG. 5.

In an embodiment, the micro-blog pushing server 600 includes a processor 602 and a memory 604. Although this disclosure describes and illustrates a particular micro-blog pushing server having a particular number of particular components in a particular arrangement, any suitable computer equipment having any suitable number of any suitable components can be contemplated.

In an embodiment, the processor 602 includes hardware for executing instructions, for example, one or more computer programs. The processor 602 may retrieve instructions from the memory 604 and execute them. The processor 602 may be implemented as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform one or more steps of at least one of the methods as described referring to FIG. 1 or implements functions of some or all of the various modules as described referring to FIG. 5.

In an embodiment, the memory 604 may store instructions for the processor 602 to execute or data for the processor 602 to operate on. In an embodiment, the memory 604 may include random access memory (RAM), which may be dynamic RAM (DRAM) or static RAM (SRAM) as desired. Additionally, the memory 604 may include storage for storing data and instructions, such as read-only memory (ROM), such as mask-programmed ROM, programmable ROM (PROM), erasable PROM (EPROM), electrically erasable PROM (EEPROM), electrically alterable ROM (EAROM), or flash memory. In an embodiment, the storage may be internal or external to the computer equipment. In an embodiment, the storage stores instructions for performing one or more steps of at least one of the methods as described referring to FIG. 1 or for implementing functions of some or all of the various modules or units as described referring to FIG. 5.

Herein, one or more non-transitory computer readable storage media may be contemplated for implementing any suitable storage. In an embodiment, a computer readable storage medium may implement at least some portions of the memory 604. The computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or any other suitable computer-readable storage medium.

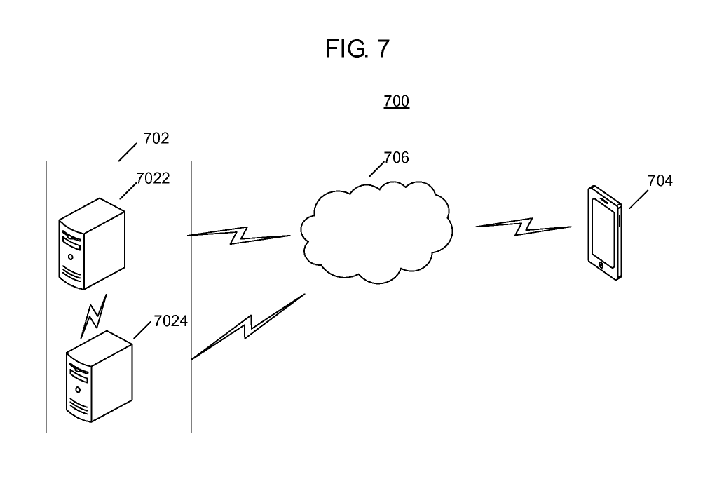

FIG. 7 illustrates a structure schematic view of a system 700 for pushing micro-blogs according to some embodiments of the disclosure. As shown in FIG. 7, the system 700 includes a network-side device 702, and terminal-side device 704, which may be connected to each other through a network 706 (for example, Internet).

In an embodiment, the network-side device 702 may include a micro-blog pushing server 7022 configured to perform the method as described with reference to FIG. 1 and a micro-blog receiving server 7024 configured to receive micro-blogs from users. In practice, the micro-blog pushing server 7022 and the micro-blog receiving server 7024 may be a same physical device or may be different physical devices. The physical structures of both the micro-blog pushing server 7022 and the micro-blog receiving server 7024 may be as same as the micro-blog pushing server 600 described with reference to FIG. 6 and thus the detailed description thereof is omitted here.

The terminal-side device 704 may include, but is not limited to, a desktop computer, a laptop, a notebook, a tablet, a mobile phone and other electronic equipment, or a client side application program.

In an embodiment, the micro-blog pushing server 7022 determines a set of content keywords and/or geographical location information keywords, each being associated with at least one of a plurality of micro-blogs received at a micro-blog receiving server 7024, creates an index of the plurality of the micro-blogs using the determined set of content keywords and/or geographical location information keywords, obtains one or more content keywords and/or geographical location information keywords, each having an interest value greater than a preset threshold, as content keywords and/or geographical location information keywords that the user is interested in, searches in the index for micro-blogs associated with the content keywords and/or geographical location information keywords that the user is interested in, sorts the micro-blogs searched out based on a predefined rule and transmits the sorted micro-blogs to the terminal-side device 704. When the micro-blogs are received by the terminal-side device 704, the user may view the micro-blogs in a micro-blogging home page.

According to the various embodiments of the disclosure, the user may acquire more contents of interest, besides a timeline view mode based on a listening relation-chain, the user may choose a timeline view mode based on contents. In other words, the user does not have to acquire information by listening to associated micro-blogging users. Accordingly, the flow of the entire micro-blogging system is enhanced and the media attribute of the micro-blogging service is elaborated.

The embodiments described above which are specific and complete merely describe several implementing modes of the present disclosure, however this cannot be understood as a limitation of the scope of the present disclosure. It should be noted that for the ordinary skilled in the art, various alterations and modifications may also be made without departing from the concept of the present disclosure, and all these shall fall in the protection scope of the present disclosure. Therefore, the protection scope of the present disclosure should be limited by the appended claims.

1. A method for pushing micro-blogs, comprising:
at a micro-blog pushing server,
determining a set of keywords, each being associated with at least one of a plurality of micro-blogs received by a micro-blog receiving server;
creating an index of the plurality of micro-blogs using the set of the keywords;
obtaining a subset of the keywords, each having an interest value greater than a preset threshold;
searching in the index for micro-blogs associated with the subset of the keywords;
sorting the micro-blogs searched out based on a predefined rule; and
transmitting the sorted micro-blogs for the user.

2. The method according to claim 1, wherein the set of keywords contain content keywords, geographical location information keywords, or both.

3. The method according to claim 1, wherein the obtaining the subset of the keywords comprises at least one of the following:
receiving the subset of the keywords input by the user;
receiving the subset of the keywords selected by the user from what are provided from the micro-blog pushing server; or
obtaining the subset of the keywords based on a historical micro-blog that the user has posted or listened to.

4. The method according to claim 3, wherein the obtaining the subset of the keywords based on the historical micro-blog that the user has posted or listened to comprises:
matching the historical micro-blog with the set of the keywords to determine whether the historical micro-blog contains one or more keywords that fall within the set of the keywords; and
when determining that the historical micro-blog contains one or more keywords that fall within the set of the keywords, taking the one or more keywords as the subset of the keywords.

5. The method according to claim 3,
wherein the subset of the keywords contain at least one content keyword, and
wherein the obtaining the subset of the keywords based on the historical micro-blog that the user has posted or listened to comprises:
obtaining the at least one content keyword, that is set by the user for the historical micro-blog after writing the historical micro-blog, as the content keyword having an interest value greater than the preset threshold.

6. The method according to claim 3,
wherein the subset of the keywords contain at least one geographical location information keyword, and
wherein the obtaining the subset of the keywords based on the historical micro-blog that the user has posted or listened to comprises:
recording a geographical location at which the historical micro-blog is transmitted; and
taking the geographical location as the geographical location information keyword having an interest value greater than the preset threshold.

7. The method according to claim 1, wherein the sorting the micro-blogs searched out based on the predefined rule comprises:
sorting the micro-blogs searched out based on at least one of a timeline, in which the micro-blogs are posted, or relevancies of the micro-blogs to the subset of the keywords.

8. A micro-blog pushing server, comprising:
a processor; and
a memory, coupled to the processor, and including instructions that, when executed, cause the processor to:
determine a set of keywords, each being associated with at least one of a plurality of micro-blogs received by a micro-blog receiving server;
create an index of the plurality of micro-blogs using the set of the keywords;
obtain a subset of the keywords, each having an interest value greater than a preset threshold;
search in the index for micro-blogs associated with the subset of the keywords;
sort the micro-blogs searched out based on a predefined rule; and
transmit the sorted micro-blogs for the user.

9. The micro-blog pushing server according to claim 8, wherein the set of keywords contain content keywords, geographical location information keywords, or both.

10. The micro-blog pushing server according to claim 8, wherein the instructions that, when executed, cause the processor to obtain the subset of the keywords comprise at least one of the following instructions that, when executed, cause the processor to:
receive the subset of the keywords input by the user;
receive the subset of the keywords selected by the user from what are provided from the micro-blog pushing server; or
obtain the subset of the keywords based on a historical micro-blog that the user has posted or listened to.

11. The micro-blog pushing server according to claim 10, wherein the instructions that, when executed, cause the processor to obtain the subset of the keywords based on the historical micro-blog that the user has posted or listened to comprise at least one of the following instructions that, when executed, cause the processor to:
match the historical micro-blog with the set of the keywords to determine whether the historical micro-blog contains one or more keywords that fall within the set of the keywords; and
when determining that the historical micro-blog contains one or more keywords that fall within the set of the keywords, take the one or more keywords as the subset of the keywords.

12. The micro-blog pushing server according to claim 10,
wherein the subset of the keywords contain at least one content keyword, and
wherein the instructions that, when executed, cause the processor to obtain the subset of the keywords based on the historical micro-blog that the user has posted or listened to comprises instructions that, when executed, cause the processor to obtain the at least one content keyword, that is set by the user for the historical micro-blog after writing the historical micro-blog, as the content keyword having an interest value greater than the preset threshold.

13. The micro-blog pushing server according to claim 10,
wherein the subset of the keywords contain at least one geographical location information keyword, and
wherein the instructions that, when executed, cause the processor to obtain the subset of the keywords based on the historical micro-blog that the user has posted or listened to comprises instructions that, when executed, cause the processor to:
record a geographical location at which the historical micro-blog is transmitted; and
take the geographical location as the geographical location information keyword having an interest value greater than the preset threshold.

14. The micro-blog pushing server according to claim 8, wherein the instructions that, when executed, cause the processor to sort the micro-blogs searched out based on the predefined rule comprises instructions that, when executed, cause the processor to sort the micro-blogs searched out based on at least one of a timeline, in which the micro-blogs are posted, or relevancies of the micro-blogs to the subset of the keywords.

15. A system, comprising:
a network-side device, comprising a micro-blog pushing server, and
a terminal-side device, configured to receive the micro-blogs from the network-side device and to present the micro-blogs,
wherein the micro-blog pushing server comprises:
a processor; and
a memory, coupled to the processor, and including instructions that, when executed, cause the processor to:
determine a set of keywords, each being associated with at least one of a plurality of micro-blogs received by a micro-blog receiving server;
create an index of the plurality of micro-blogs using the set of the keywords;
obtain a subset of the keywords, each having an interest value greater than a preset threshold;
search in the index for micro-blogs associated with the subset of the keywords;
sort the micro-blogs searched out based on a predefined rule; and
transmit the sorted micro-blogs for the user.

16. The system according to claim 15, wherein the set of keywords contain content keywords, geographical location information keywords, or both.

17. The system according to claim 15, wherein the instructions that, when executed, cause the processor to obtain the subset of the keywords comprise at least one of the following instructions that, when executed, cause the processor to:
receive the subset of the keywords input by the user;
receive the subset of the keywords selected by the user from what are provided from the micro-blog pushing server; or
obtain the subset of the keywords based on a historical micro-blog that the user has posted or listened to.

18. The system according to claim 17, wherein the instructions that, when executed, cause the processor to obtain the subset of the keywords based on the historical micro-blog that the user has posted or listened to comprise at least one of the following instructions that, when executed, cause the processor to:
match the historical micro-blog with the set of the keywords to determine whether the historical micro-blog contains one or more keywords that fall within the set of the keywords; and
when determining that the historical micro-blog contains one or more keywords that fall within the set of the keywords, take the one or more keywords as the subset of the keywords.

19. The system according to claim 17,
wherein the subset of the keywords contain at least one content keyword, and
wherein the instructions that, when executed, cause the processor to obtain the subset of the keywords based on the historical micro-blog that the user has posted or listened to comprises instructions that, when executed, cause the processor to obtain the at least one content keyword, that is set by the user for the historical micro-blog after writing the historical micro-blog, as the content keyword having an interest value greater than the preset threshold.

20. The system according to claim 17,
wherein the subset of the keywords contain at least one geographical location information keyword, and
wherein the instructions that, when executed, cause the processor to obtain the subset of the keywords based on the historical micro-blog that the user has posted or listened to comprises instructions that, when executed, cause the processor to:
record a geographical location at which the historical micro-blog is transmitted; and
take the geographical location as the geographical location information keyword having an interest value greater than the preset threshold.
